(19) United States
(12) Patent Application Publication
(10) Pub. No.: US 2022/0398479 A1
(43) Pub. Date: Dec. 15, 2022

(54) REASONING WITH REAL-VALUED PROPOSITIONAL LOGIC AND PROBABILITY INTERVALS

(71) Applicant: International Business Machines Corporation, Armonk, NY (US)

(72) Inventor: Radu Marinescu, Dublin (IE)

(21) Appl. No.: 17/346,913

(22) Filed: Jun. 14, 2021

(51) Int. Cl. G06N 7/04; G06N 7/02; G06N 7/00

(52) U.S. Cl. CPC G06N 7/046; G06N 7/023; G06N 7/026; G06N 7/005

(57) ABSTRACT

In an approach for reasoning with real-valued propositional logic, a processor receives a set of propositional logic formulae, a set of intervals representing upper and lower bounds on truth values of a set of atomic propositions in the set of propositional logic formulae, and a query. A processor generates a logical neural network based on the set of propositional logic formulae and the set of intervals representing upper and lower bounds on truth values. A processor generates a credal network with a same structure of the logical neural network. A processor runs probabilistic inference on the credal network to compute a conditional probability based on the query. A processor outputs the conditional probability as an answer to the query.

### BACKGROUND

The present disclosure relates generally to the field of artificial intelligence and neural networks, and more particularly to reasoning with real-valued propositional logic and probability intervals.

Artificial intelligence may refer to a broad set of methods, algorithms, and technologies that enable systems, either in software or embodied forms, to display aspects of intelligent behavior in a way that may seem human-like to an outside observer. In logic, an infinite-valued logic (or real-valued logic) is a many-valued logic in which truth values comprise a continuous range. Traditionally, in Aristotle's logic, logic other than bivalent logic was abnormal, as the law of the excluded middle precluded more than two possible values (i.e., “true” and “false”) for any proposition. Infinite-valued logic may be a real-valued logic in which sentences from sentential calculus may be assigned a truth value of not only zero or one but also any real number in between.

### SUMMARY

Aspects of an embodiment of the present disclosure disclose an approach for reasoning with real-valued propositional logic. A processor receives a set of propositional logic formulae, a set of intervals representing upper and lower bounds on truth values of a set of atomic propositions in the set of propositional logic formulae, and a query. A processor generates a logical neural network based on the set of propositional logic formulae and the set of intervals representing upper and lower bounds on truth values. A processor generates a credal network with a same structure of the logical neural network. A processor runs probabilistic inference on the credal network to compute a conditional probability based on the query. A processor outputs the conditional probability as an answer to the query.

### BRIEF DESCRIPTION OF THE DRAWINGS

FIG. 1 is a functional block diagram illustrating a probabilistic query environment, in accordance with an embodiment of the present disclosure.

FIG. 2 is a flowchart depicting operational steps of a cognitive engine within a computing device of FIG. 1, in accordance with an embodiment of the present disclosure.

FIG. 3 illustrates an exemplary functional diagram of the cognitive engine within the computing device of FIG. 1, in accordance with an embodiment of the present disclosure.

FIG. 4 illustrates an example of generating a logical neural network of the cognitive engine within the computing device of FIG. 1, in accordance with an embodiment of the present disclosure.

FIGS. 5A-5C illustrate an example of generating credal network of the cognitive engine within the computing device of FIG. 1, in accordance with an embodiment of the present disclosure.

FIG. 6 is a block diagram of components of the computing device of FIG. 1, in accordance with an embodiment of the present disclosure.

### DETAILED DESCRIPTION

The present disclosure is directed to systems and methods for reasoning with real-valued propositional logic as well as with probability intervals associated with atomic propositions in a knowledge base.

Embodiments of the present disclosure recognize a need for using real-valued logic instead of classical logic which is known to be quite brittle. For example, in many practical situations, acquiring knowledge is a noisy process (e.g., extracting logical representations from text). Reasoning with the kind of knowledge may therefore be prone to errors. Embodiments of the present disclosure disclose performing reasoning with real-valued propositional logic under conditions of uncertainty. Embodiments of the present disclosure disclose converting propositional formulae in a knowledge base into real-valued propositional logic formulae. Embodiments of the present disclosure disclose allowing the truth value of a proposition/formulae to be a real number between 0 and 1 instead of either 0 (false) or 1 (true). In addition, to account for uncertainty in the estimates of the truth values, embodiments of the present disclosure disclose calculating upper and lower bounds on the truth values of the propositions in the knowledge base. Embodiments of the present disclosure disclose calculating upper and lower bounds on the probability of the query formula being true.

Embodiments of the present disclosure disclose answering probabilistic queries of a form P(A|B) where A and B are two propositions or formulas in the knowledge base, i.e., what is the probability of proposition A being true given that proposition B is true. Embodiments of the present disclosure disclose performing reasoning with real-valued propositional logic under conditions of uncertainty. Embodiments of the present disclosure disclose bounding the uncertainty in a principled manner using probability intervals and therefore allowing for more flexibility in the reasoning process. Embodiments of the present disclosure disclose considering upper and lower bounds on the truth values of the propositions instead of point estimates.

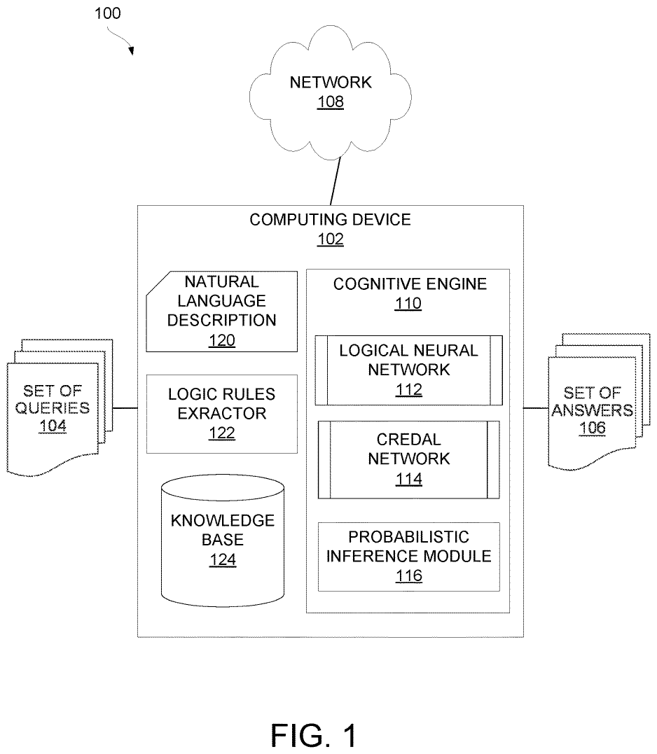

The present disclosure will now be described in detail with reference to the Figures. FIG. 1 is a functional block diagram illustrating probabilistic query environment, generally designated 100, in accordance with an embodiment of the present disclosure.

In the depicted embodiment, probabilistic query environment 100 includes computing device 102, set of queries 104, set of answers 106, and network 108. In the depicted embodiment, queries 104 are a set of queries, and answers 106 are a set of answers respectively. In another embodiment, queries 104 can be an individual query, and answers 106 can be an individual answer respectively. In an example, a query in set of queries 104 may be a query (A, B) where A and B are two propositions or formulas in knowledge base 124. An answer may be an answer to the query of the probability of proposition A being true given that proposition B is true.

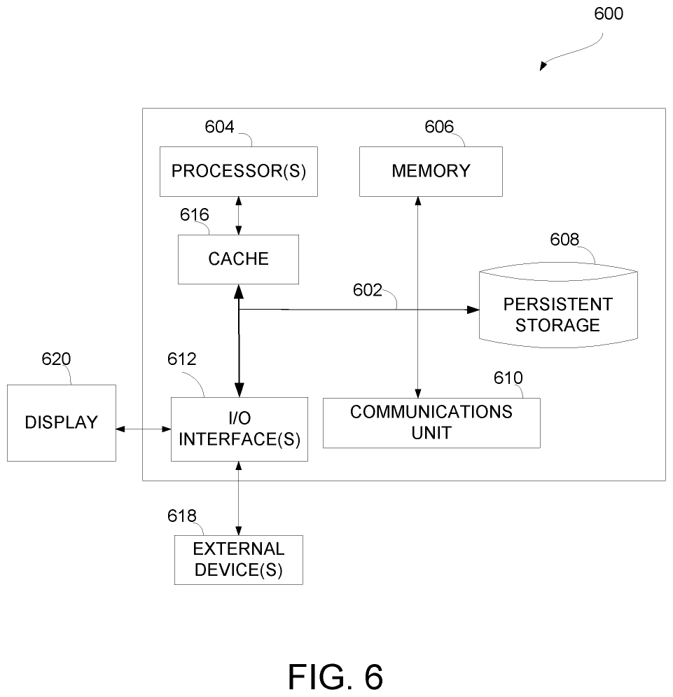

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to cognitive engine 110 and network 108 and is capable of processing program instructions and executing cognitive engine 110, in accordance with an embodiment of the present disclosure. Computing device 102 may include internal and external hardware components, as depicted and described in further detail with respect to FIG. 6.

Further, in the depicted embodiment, computing device 102 includes cognitive engine 110, natural language description 120, logic rules extractor 122, and knowledge base 124. In the depicted embodiment, cognitive engine 110, natural language description 120, logic rules extractor 122, and knowledge base 124 are located on computing device 102. However, in other embodiments, cognitive engine 110, natural language description 120, logic rules extractor 122, and knowledge base 124 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102 and cognitive engine 110, natural language description 120, logic rules extractor 122, and knowledge base 124, in accordance with a desired embodiment of the disclosure.

In one or more embodiments, natural language description 120 may be a language description of a domain problem. Natural language description 120 may include any natural text. Natural language description 120 may state facts, issues, questions or any other statements in a domain problem. Natural language description 120 may be taken as an input of logic rules extractor 122. In one or more embodiments, logic rules extractor 122 is configured to extract propositional logic formulae from natural language description 120. Logic rules extractor 122 may extract logical rules from natural language description 120. Logic rules extractor 122 may output a formal propositional logic encoding of natural language description 120. Logic rules extractor 122 may extract propositional logic formulae and rules from natural language description 120 using an end-to-end neural model. For example, logic rules extractor 122 may use a sequence-to-sequence learning model to extract propositional logic formulae and rules from natural language description 120. A sequence-to-sequence model may be a special class of recurrent neural network architectures. A sequence-to-sequence model may convert sequences from one domain to sequences in another domain. In an example, let M be a sequence-to-sequence model (e.g., logic rules extractor 122) and let D be a dataset consisting of pairs (T, L) where T is a text description (e.g., natural language description 120) and L is an equivalent propositional logical representation. The propositions can be drawn from a fixed set of symbols. Logic rules extractor 122 may be trained with the dataset D using a standard back-propagation algorithm for neural networks. Logic rules extractor 122 may apply natural language description 120 as input and may return the resulting logical representation as output. Logic rules extractor 122 may store the resulting logical representation into knowledge base 124. Knowledge base 124 may contain propositional logic formulae extracted by logic rules extractor 122 from natural language description 120. Knowledge base 124 may contain propositional logic formulae entered by a user. Knowledge base 124 may include any other underlying set of facts, assumptions, and logic rules available to solve a problem. Propositional logic formulae in knowledge base 124 may be real-valued propositional logic formulae (e.g., Lukasiewicz logic). The truth value of a proposition/formulae may be a real number between 0 and 1 instead of either 0 (false) or 1 (true). The truth value of the propositions in knowledge base 124 may include upper and lower bounds.

Further, in the depicted embodiment, cognitive engine 110 includes logical neural network 112, credal network 114, and probabilistic inference module 116. In the depicted embodiment, logical neural network 112, credal network 114, and probabilistic inference module 116 are located on computing device 102 and cognitive engine 110. However, in other embodiments, logical neural network 112, credal network 114, and probabilistic inference module 116 may be located externally and accessed through a communication network such as network 108.

In one or more embodiments, cognitive engine 110 is configured to take as input a set of propositional logic formulae, a set of intervals representing upper and lower bounds on the truth values of a set of atomic propositions in the set of propositional logic formulae, and a query Q (A, B) where A and B are propositions in the set of propositional logic formulae. The set of propositional logic formulae may be from knowledge base 124. The set of intervals representing upper and lower bounds on the truth values of a set of atomic propositions may be from knowledge base 124. The query Q (A, B) may be one of set of queries 104. The query Q (A, B) may be from a user.

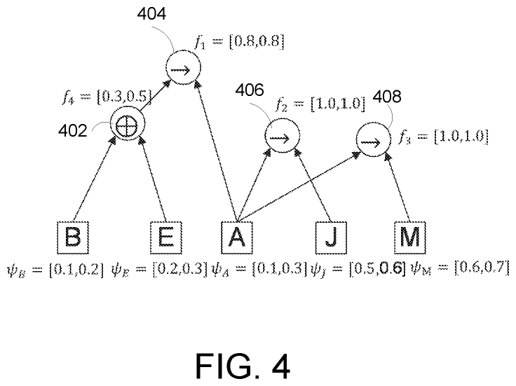

In one or more embodiments, cognitive engine 110 is configured to generate logical neural network 112 based on the set of propositional logic formulae and the set of intervals representing upper and lower bounds on the truth values. Logical neural network 112 may be a form of recurrent neural network with a 1-to-1 correspondence to a set of logical formulae in any of various systems of weighted, real-valued logic, in which evaluation performs logical inference. Cognitive engine 110 may calculate truth values for operator nodes in logical neural network 112. Cognitive engine 110 may create a directed acyclic graph comprising the syntax trees of the formulae in the set of propositional logic formulae. Cognitive engine 110 may attach input truth value bounds to nodes in a bottom layer of logical neural network 112. Cognitive engine 110 may compute truth value bounds for the connector nodes in upper layers of logical neural network 112. Cognitive engine 110 may convert propositional formulae into real-valued propositional logic formulae (e.g., Lukasiewicz logic). Cognitive engine 110 may allow the truth value of a proposition/formulae to be a real number between 0 and 1 instead of either 0 (false) or 1 (true). Further details in generating logical neural network 112 are depicted and illustrated in an example of FIG. 4.

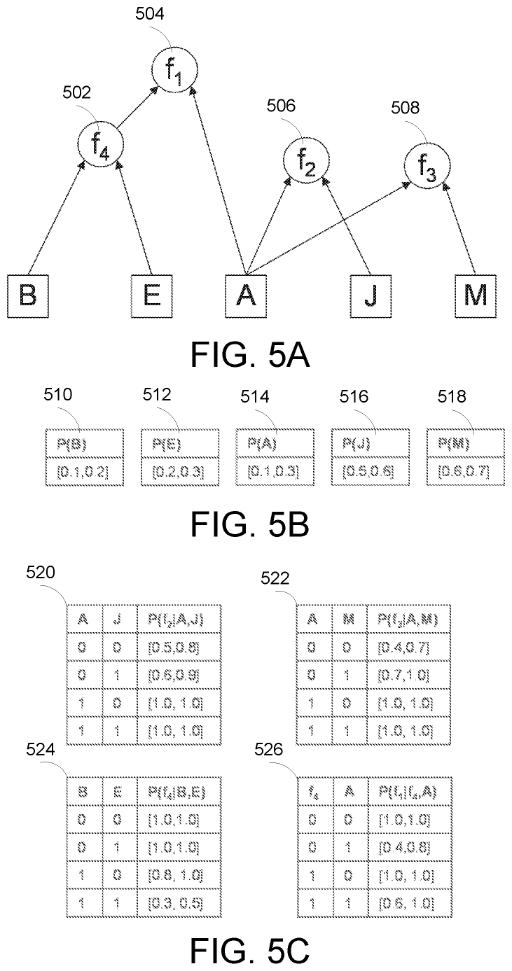

In one or more embodiments, cognitive engine 110 is configured to generate credal network 114 based on logical neural network 112. Cognitive engine 110 may generate credal network 114 with the same structure of logical neural network 112. In general, credal network 114 may be a probabilistic graphical model based on imprecise probability. Credal network 114 can be regarded as an extension of a Bayesian network, where a credal set replaces a probability mass function in the specification of the local model for the network variables. Inference on credal network 114 may be intended as the computation of the bounds of an expectation with respect to its strong extensions. In an example, nodes in logical neural network 112 may correspond to propositions (bottom layer) or connectors (upper layers) in credal network 114. Cognitive engine 110 may calculate interval probability tables (operators) for each node in credal network 114. Further details in generating credal network 114 are depicted and illustrated in an example of FIGS. 5A-5C.

In one or more embodiments, cognitive engine 110 is configured to run probabilistic inference on credal network 114 to compute a conditional probability in the form of P(A|B) where A and B are two propositions or formulas in knowledge base 124, i.e., what is the probability of proposition A being true given that proposition B is true. In an example, A and B can be arbitrary formulae obtained from atomic propositions in the set of propositional logic formulae using logical connectors. Cognitive engine 110 may run a probabilistic inference algorithm for credal network 114. For example, cognitive engine 110 may use a Loopy 2U algorithm to run the inference for credal network 114. Cognitive engine 110 may answer probabilistic queries of the form P(A|B). Cognitive engine 110 may return and output the conditional probability P(A|B).

In one or more embodiments, probabilistic inference module 116 is configured to run probabilistic inference on credal network 114 to compute a conditional probability in the form of P(A|B) where A and B are two propositions or formulas in knowledge base 124, i.e., what is the probability of proposition A being true given that proposition B is true. In an example, A and B can be arbitrary formulae obtained from atomic propositions in the set of propositional logic formulae using logical connectors. Probabilistic inference module 116 may run a probabilistic inference algorithm for credal network 114. For example, probabilistic inference module 116 may use a Loopy 2U algorithm to run the inference for credal network 114. Probabilistic inference module 116 may answer probabilistic queries of the form P(A|B). Probabilistic inference module 116 may return and output the conditional probability P(A|B).

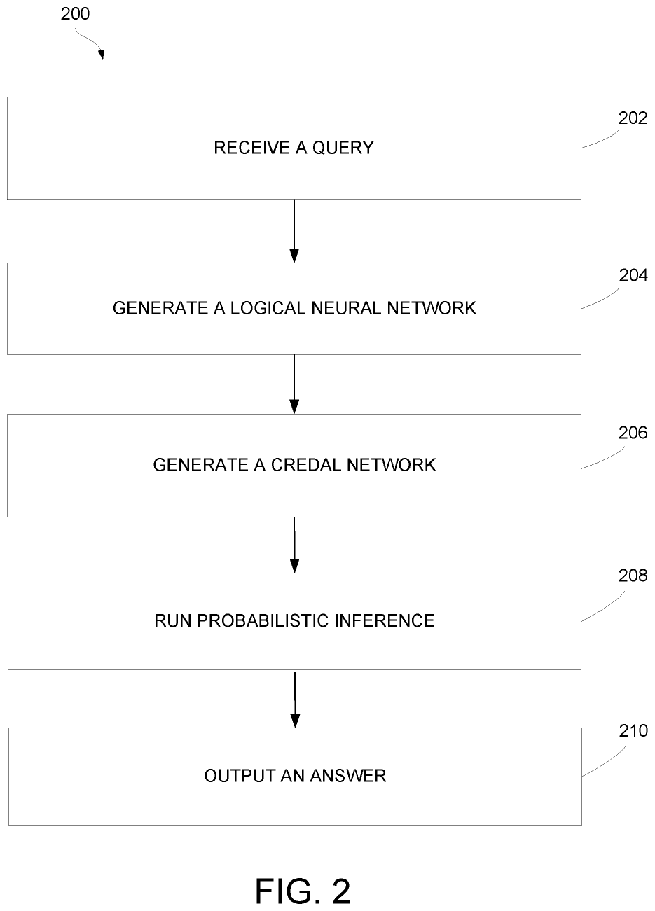

FIG. 2 is a flowchart 200 depicting operational steps of cognitive engine 110 in accordance with an embodiment of the present disclosure.

Cognitive engine 110 operates to receive a query on what is the probability of proposition A being true given that proposition B is true, where A and B are two propositions or formulas in knowledge base 124. Cognitive engine 110 may take as input a set of propositional logic formulae, and a set of intervals representing upper and lower bounds on the truth values of a set of atomic propositions in the set of propositional logic formulae. Cognitive engine 110 also operates to generate logical neural network 112 based on the set of propositional logic formulae and the set of intervals representing upper and lower bounds on the truth values. Cognitive engine 110 operates to generate credal network 114 based on logical neural network 112. Cognitive engine 110 may generate credal network 114 with the same structure of logical neural network 112. Cognitive engine 110 operates to run probabilistic inference on credal network 114 to compute a conditional probability in the form of P(A|B) where A and B are two propositions or formulas in knowledge base 124, i.e., what is the probability of proposition A being true given that proposition B is true. Cognitive engine 110 operates to output the conditional probability P(A|B) where A and B are two propositions or formulas in knowledge base 124.

In step 202, cognitive engine 110 receives a query on what is the probability of proposition A being true given that proposition B is true, where A and B are two propositions or formulas in knowledge base 124. Cognitive engine 110 may take as input a set of propositional logic formulae, and a set of intervals representing upper and lower bounds on the truth values of a set of atomic propositions in the set of propositional logic formulae. The set of propositional logic formulae may be from knowledge base 124. The set of intervals representing upper and lower bounds on the truth values of a set of atomic propositions may be from knowledge base 124. The query may be one of set of queries 104. The query may be from a user.

In step 204, cognitive engine 110 generates logical neural network 112 based on the set of propositional logic formulae and the set of intervals representing upper and lower bounds on the truth values. Logical neural network 112 may be a form of recurrent neural network with a 1-to-1 correspondence to a set of logical formulae in any of various systems of weighted, real-valued logic, in which evaluation performs logical inference. Cognitive engine 110 may calculate the truth values for operator nodes in logical neural network 112. Cognitive engine 110 may create a directed acyclic graph comprising the syntax trees of the formulae in the set of propositional logic formulae. Cognitive engine 110 may attach input truth value bounds to nodes in a bottom layer of logical neural network 112. Cognitive engine 110 may compute truth value bounds for the connector nodes in upper layers of logical neural network 112. Cognitive engine 110 may convert propositional formulae into real-valued propositional logic formulae (e.g., Lukasiewicz logic). Cognitive engine 110 may allow the truth value of a proposition/formulae to be a real number between 0 and 1 instead of either 0 (false) or 1 (true). Further details in generating logical neural network 112 are depicted and illustrated in an example of FIG. 4.

In step 206, cognitive engine 110 generates credal network 114 based on logical neural network 112. Cognitive engine 110 may generate credal network 114 with the same structure of logical neural network 112. In general, credal network 114 may be a probabilistic graphical model based on imprecise probability. Credal network 114 can be regarded as an extension of a Bayesian network, where a credal set replaces a probability mass function in the specification of the local model for the network variables. Inference on credal network 114 may be intended as the computation of the bounds of an expectation with respect to its strong extensions. In an example, nodes in logical neural network 112 may correspond to propositions (bottom layer) or connectors (upper layers) in credal network 114. Cognitive engine 110 may calculate interval probability tables (operators) for each node in credal network 114. Further details in generating credal network 114 are depicted and illustrated in an example of FIGS. 5A-5C.

In step 208, cognitive engine 110 runs probabilistic inference on credal network 114 to compute a conditional probability in the form of P(A|B) where A and B are two propositions or formulas in knowledge base 124, i.e., what is the probability of proposition A being true given that proposition B is true. In an example, A and B can be arbitrary formulae obtained from atomic propositions in the set of propositional logic formulae using logical connectors. Cognitive engine 110 may run a probabilistic inference algorithm for credal network 114. For example, cognitive engine 110 may use a Loopy 2U algorithm to run the inference for credal network 114.

In step 210, cognitive engine 110 outputs the conditional probability P(A|B) where A and B are two propositions or formulas in knowledge base 124. Cognitive engine 110 may answer the query of the form P(A|B) with the inference result.

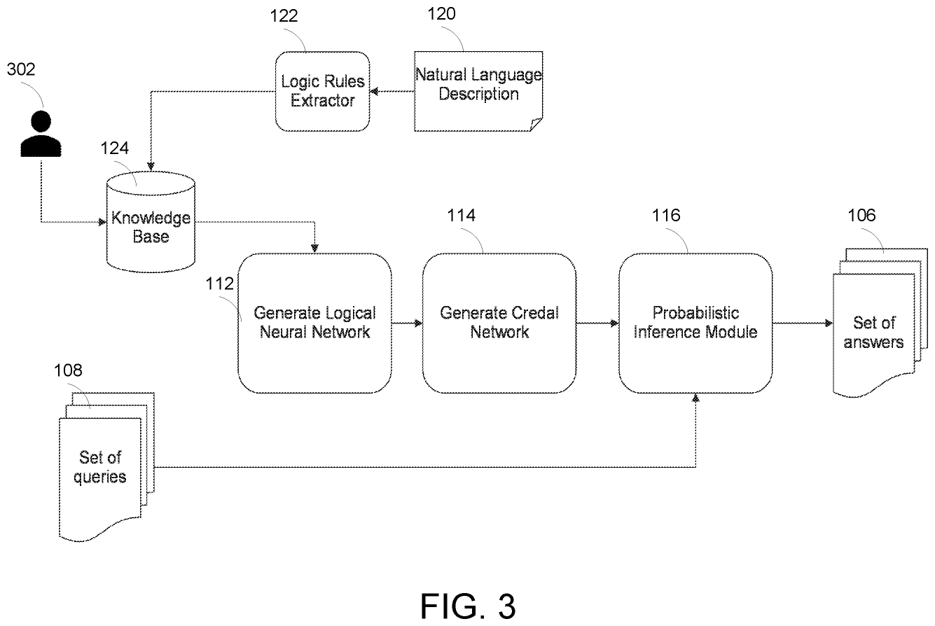

FIG. 3 illustrates an exemplary functional diagram of cognitive engine 110, in accordance with an embodiment of the present disclosure.

In the example of FIG. 3, logic rules extractor 122 may extract propositional logic formulae and logical rules from natural language description 120. Logic rules extractor 122 may use an end-to-end neural model to extract propositional logic formulae and logical rules from natural language description 120. Logic rules extractor 122 may store the extracted propositional logic formulae and logical rules into knowledge base 124. Knowledge base 124 may contain propositional logic formulae extracted by logic rules extractor 122 from natural language description 120. Knowledge base 124 may contain propositional logic formulae entered by user 302. Cognitive engine 110 may take as input, from knowledge base 124, a set of propositional logic formulae and a set of intervals representing upper and lower bounds on the truth values of a set of atomic propositions in the set of propositional logic formulae. Cognitive engine 110 may generate logical neural network 112 based on the set of propositional logic formulae and the set of intervals representing upper and lower bounds on the truth values. Cognitive engine 110 may generate credal network 114 based on logical neural network 112. Cognitive engine 110 may generate credal network 114 with the same structure of logical neural network 112. Cognitive engine 110 may run probabilistic inference on credal network 114 through probabilistic inference module 116 to compute a conditional probability. Probabilistic inference module 116 may take as input a set of queries 104 and may output a set of answers 106 based on the inference running results respectively.

FIG. 4 illustrates an example of generating logical neural network 112, in accordance with an embodiment of the present disclosure.

In the example of FIG. 4, cognitive engine 110 may generate logical neural network 112 based on a set of propositional logic formulae and a set of intervals representing upper and lower bounds on the truth values. In the example, the set of propositional logic formulae may include F₁: B⊕E→A, F₂: A→J, and F₃: A→M. In F₁, B or E implies A. In F₂, A implies J. In F₃, A implies M. The set of intervals representing upper and lower bounds on the truth values may be Ψ_{B}=[0.1,0.2], Ψ_{E}=[0.2,0.3], Ψ_{A}=[0.1,0.3], Ψ_{J}=[0.5,0.6], and Ψ_{M}=[0.6,0.7], respectively for B, E, A, J and M. In an example, cognitive engine 110 may use various real-valued logic operators, for example, p→q=min(1, 1−p+q), p⊕q=min(1, p+q), p⊗q=max(0, p+q−1). Other real-valued logic operators are possible. Cognitive engine 110 may calculate truth values for operator notes. In the example, the truth values for notes 402, 404, 406, 408 are calculated as f₄=[0.3,0.5], f₁=[0.8,0.8], f₂=[1.0,1.0], and f₃=[1.0,1.0] respectively.

FIGS. 5A-5C illustrate an example of generating credal network 114, in accordance with an embodiment of the present disclosure.

In the example of FIGS. 5A-5C, cognitive engine may generate credal network 114 based on logical neural network 112. Cognitive engine 110 may generate credal network 114 with the same structure of logical neural network 112, e.g., as shown in FIG. 4. In the example, nodes 502, 504, 506, 508 in credal network 114 correspond notes 402, 404, 406, 408 in logical neural network 112. The intervals representing upper and lower bounds on the truth values for B, E, A, J and M are P(B)=[0.1,0.2] 510, P(E)=[0.2,0.3] 512, P(A)=[0.1,0.3] 514, P(J)=[0.5,0.6] 516, and P(M)=[0.6,0.7] 518 respectively. Cognitive engine 110 may calculate interval conditional probability tables 520, 522, 524, 526 for f₂, f₃, f₄, and f₁ respectively. Cognitive engine 110 may run probabilistic inference on credal network 114 to compute a conditional probability. In the example, the inference result is P(B=true|M=true)∈[0.172,0.192].

FIG. 6 depicts a block diagram 600 of components of computing device 102 in accordance with an illustrative embodiment of the present disclosure. It should be appreciated that FIG. 6 provides only an illustration of one implementation and does not imply any limitations with regard to the environments in which different embodiments may be implemented. Many modifications to the depicted environment may be made.

Computing device 102 may include communications fabric 602, which provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of computer processor(s) 604 by holding recently accessed data, and data near accessed data, from memory 606.

Cognitive engine 110 may be stored in persistent storage 608 and in memory 606 for execution by one or more of the respective computer processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Cognitive engine 110 may be downloaded to persistent storage 608 through communications unit 610.

I/O interface(s) 612 allows for input and output of data with other devices that may be connected to computing device 102. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention, e.g., cognitive engine 110 can be stored on such portable computer readable storage media and can be loaded onto persistent storage 608 via I/O interface(s) 612. I/O interface(s) 612 also connect to display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method comprising:
receiving, by one or more processors, a set of propositional logic formulae, a set of intervals representing upper and lower bounds on truth values of a set of atomic propositions in the set of propositional logic formulae, and a query;
generating, by one or more processors, a logical neural network based on the set of propositional logic formulae and the set of intervals representing upper and lower bounds on truth values;
generating, by one or more processors, a credal network with a same structure of the logical neural network;
running, by one or more processors, probabilistic inference on the credal network to compute a conditional probability based on the query; and
outputting, by one or more processors, the conditional probability as an answer to the query.

2. The computer-implemented method of claim 1, further comprising:
extracting, by one or more processors, the propositional logic formulae from text using an end-to-end neural model.

3. The computer-implemented method of claim 1, wherein generating the logical neural network comprises:
attaching the input truth value bounds to bottom nodes in a bottom layer of the logical neural network; and
calculating truth value bounds for connector nodes in an upper layer of the logical neural network.

4. The computer-implemented method of claim 1, wherein generating the credal network comprises calculating a conditional probability table for a node in the credal network.

5. The computer-implemented method of claim 1, wherein the truth values are a real number between 0 and 1.

6. The computer-implemented method of claim 1, wherein the query includes a first proposition and a second proposition to inquire probability of the first proposition being true given that the second proposition is true.

7. The computer-implemented method of claim 6, wherein the first proposition and the second proposition are arbitrary formulae obtained from the atomic propositions in the propositional logic formulae using a logical connector.

8. A computer program product comprising:
one or more computer readable storage media, and program instructions collectively stored on the one or more computer readable storage media, the program instructions comprising:
program instructions to receive a set of propositional logic formulae, a set of intervals representing upper and lower bounds on truth values of a set of atomic propositions in the set of propositional logic formulae, and a query;
program instructions to generate a logical neural network based on the set of propositional logic formulae and the set of intervals representing upper and lower bounds on truth values;
program instructions to generate a credal network with a same structure of the logical neural network;
program instructions to run probabilistic inference on the credal network to compute a conditional probability based on the query; and
program instructions to output the conditional probability as an answer to the query.

9. The computer program product of claim 8, further comprising:
program instructions to extract the propositional logic formulae from text using an end-to-end neural model.

10. The computer program product of claim 8, wherein program instructions to generate the logical neural network comprise:
program instructions to attach the input truth value bounds to bottom nodes in a bottom layer of the logical neural network; and
program instructions to calculate truth value bounds for connector nodes in an upper layer of the logical neural network.

11. The computer program product of claim 8, wherein program instructions to generate the credal network comprise program instructions to calculate a conditional probability table for a node in the credal network.

12. The computer program product of claim 8, wherein the truth values are a real number between 0 and 1.

13. The computer program product of claim 8, wherein the query includes a first proposition and a second proposition to inquire probability of the first proposition being true given that the second proposition is true.

14. The computer program product of claim 13, wherein the first proposition and the second proposition are arbitrary formulae obtained from the atomic propositions in the propositional logic formulae using a logical connector.

15. A computer system comprising:
one or more computer processors, one or more computer readable storage media, and program instructions stored on the one or more computer readable storage media for execution by at least one of the one or more computer processors, the program instructions comprising:
program instructions to receive a set of propositional logic formulae, a set of intervals representing upper and lower bounds on truth values of a set of atomic propositions in the set of propositional logic formulae, and a query;
program instructions to generate a logical neural network based on the set of propositional logic formulae and the set of intervals representing upper and lower bounds on truth values;
program instructions to generate a credal network with a same structure of the logical neural network;
program instructions to run probabilistic inference on the credal network to compute a conditional probability based on the query; and
program instructions to output the conditional probability as an answer to the query.

16. The computer system of claim 15, further comprising:
program instructions to extract the propositional logic formulae from text using an end-to-end neural model.

17. The computer system of claim 15, wherein program instructions to generate the logical neural network comprise:
program instructions to attach the input truth value bounds to bottom nodes in a bottom layer of the logical neural network; and
program instructions to calculate truth value bounds for connector nodes in an upper layer of the logical neural network.

18. The computer system of claim 15, wherein program instructions to generate the credal network comprise program instructions to calculate a conditional probability table for a node in the credal network.

19. The computer system of claim 15, wherein the truth values are a real number between 0 and 1.

20. The computer system of claim 15, wherein the query includes a first proposition and a second proposition to inquire probability of the first proposition being true given that the second proposition is true.
